(19) United States
(12) Patent Application Publication
(10) Pub. No.: US 2025/0304731 A1
(43) Pub. Date: Oct. 2, 2025

(54) PRODUCTION OF ALKYL(METH)ACRYLATE POLYESTER COPOLYMERS BY MEANS OF SUSPENSION POLYMERIZATION

(71) Applicant: Röhm GmbH, Darmstadt (DE)

(72) Inventors: Bruno Keller, Wackernheim (DE); Stefan Bernhardt, Koeln (DE); Janos Lotz, Gelnhausen (DE)

(73) Assignee: Röhm GmbH, Darmstadt (DE)

(21) Appl. No.: 18/861,725

(22) PCT Filed: Apr. 28, 2023
(86) PCT No.: PCT/EP2023/061208

§ 371 Date: Oct. 30, 2024

(30) Foreign Application Priority Data
May 6, 2022 (EP) 22171949.5

(51) Int. Cl. C08F 220/14; C08F 2/18; C08F 4/04; C08F 4/34; C09D 11/107

(52) U.S. Cl. CPC C08F 220/14; C08F 2/18; C08F 4/04; C08F 4/34; C09D 11/107

(57) ABSTRACT

A process produces alkyl (meth)acrylate-polyester copolymers by suspension polymerization. The process avoids styrene in production and allows for a fast, solvent-free production of polymer mixtures. The alkyl (meth)acrylate-polyester copolymers find application as binders in printing inks and have a very good adhesion to polyethylene terephthalate (PET), polyvinyl chloride (PVC), polypropylene (PP), polybutylene terephthalate (PBT), and polystyrene (PS).

### FIELD OF THE INVENTION

The present invention relates to a process for producing alkyl (meth)acrylate-polyester copolymers by suspension polymerization and to the alkyl (meth)acrylate-polyester copolymers thus produced. The process of the invention avoids in particular the use of styrene in production. The alkyl (meth)acrylate-polyester copolymers produced according to the invention can be used in particular as binders in printing inks.

### PRIOR ART

WO 2007/098819 A1 describes a composition that comprises a copolyester, a (meth)acrylate homo- or copolymer, and a graft copolymer of both of these Production is carried out in the absence of styrene, as a solution polymerization or substance polymerization.

The composition described in WO 2007/098819 A1 already has good properties as a compatibilizer and can accordingly be used as a binder for printing inks. However, its production is laborious and cost-intensive. Moreover, production in the form of a solution polymerization affords the composition described in WO 2007/098819 A1 as a dissolved composition, which means that the solvent in the later use of the composition is determined by the solvent employed in the solution polymerization, in particular propyl acetate. The user thus forfeits the free choice of solvent in the later use of the composition.

JP 11158204 describes the suspension polymerization of a monomer mixture comprising styrene and an ethylenically unsaturated polyester, in which polyvinyl alcohol is used as an emulsifier. The described process produces polymer particles of uniform size.

JP 09241490 describes the suspension polymerization of a monomer mixture comprising a polyethylene terephthalate, a vinyl monomer, and an unsaturated carboxylic acid amide in the presence of a germanium catalyst. The polymer obtained can be used inter alia for the production of films and moldings.

EP 0 462 785 describes a resin composition for toners that comprises a suspension polymer of a polyester, a vinyl monomer, and a divinyl monomer. The polyester is a polycondensate of terephthalic acid, isophthalic acid, a hydroxyphenylpropane, and various glycols.

The copolymers of vinyl monomers and polyesters described in the prior art do not in some cases have sufficiently good properties for use as compatibilizers and as binders in printing inks. In addition, some of them contain styrene However, in various applications, for example in areas with food contact or in articles with which children come into direct contact, aromatic monomers such as styrene are undesirable, if not prohibited. In addition, aromatic monomers often give rise to odor nuisance in the later use of the copolymers.

### OBJECT

There is therefore a need for a process for producing polymer mixtures comprising alkyl (meth)acrylate-polyester copolymers in which the disadvantages of the processes described in the prior art are present to a lesser degree or are absent altogether. In addition, the polymer mixture comprising the alkyl (meth)acrylate-polyester copolymer should be particularly suitable as a binder in printing inks.

### Achievement of Object

This object was achieved by a process for producing a polymer mixture that comprises an alkyl (meth)acrylate-polyester copolymer, comprising the steps of:
a) providing a first liquid phase comprising at least one alkyl (meth)acrylate monomer and at least one polyester dissolved in the alkyl (meth)acrylate monomer,
b) providing a second liquid phase comprising water and at least one suspension aid dispersed therein,
c) dispersing the first liquid phase in the second liquid phase, wherein droplets of the first liquid phase form in the second liquid phase,
d) polymerizing the at least one alkyl (meth)acrylate monomer present in the first liquid phase and the at least one polyester to obtain the polymer mixture comprising the alkyl (meth)acrylate-polyester copolymer.
   wherein the polymerization in step d) is initiated by at least one initiator that is provided either in the first liquid phase in step a) or in the second liquid phase in step b), wherein the at least one polyester includes polycarboxylic acid units and polyol units, and wherein the at least one polyester includes in the range from 0.1 to 10 mol % of polycarboxylic acid units having C—C double bond, based on the total amount of polycarboxylic acid units.

It was surprisingly found that polymer mixtures can be produced by the process of the invention that are suitable as binders for printing inks and that have a very good adhesion to polyethylene terephthalate (PET), polyvinyl chloride (PVC), polypropylene (PP), polybutylene terephthalate (PBT), and polystyrene (PS) in particular. At the same time, the use of styrene in the process of the invention can be dispensed with.

The process of the invention also allows fast, solvent-free production of polymer mixtures. Through the process of the invention, the polymer mixtures can be obtained in solid form without the need for a laborious removal of solvent. In the use of the polymer mixture produced according to the invention there is thus no restriction to a particular solvent. This is particularly advantageous when the polymer mixtures produced according to the invention are used for example as binders in printing inks, since solvents such as ethyl acetate that are commonplace in printing inks can, for example, be used too.

Since the polymer mixtures are obtained as a solid that is essentially free of solvent, later use is not tied to a specific solvent system, as is the case in production by solution polymerization, for example. Because the polymer mixtures obtained do not contain solvent, their transport and storage costs are significantly reduced.

The process of the invention also permits very good space-time yields and known apparatus can be used. At the same time, gelation of the alkyl (meth)acrylate-polyester copolymer present in the polymer mixture is avoided by the process of the invention.

Surprisingly, it was also found that the polymer mixtures produced according to the invention have properties comparable to those of copolymers described in the prior art, even though in a preferred embodiment of the process of the invention they contain less polyester. The lower proportion of polyester also has a beneficial effect on the overall costs of the process of the invention

The process of the invention is elucidated more particularly hereinbelow.

In step a) of the process of the invention, a first liquid phase comprising at least one alkyl (meth)acrylate monomer and at least one polyester dissolved in the alkyl (meth)acrylate monomer is provided.

To provide the first liquid phase, the at least one polyester is dissolved in the at least one alkyl (meth)acrylate monomer. The dissolution of the at least one polyester can be effected by any method known to those skilled in the art. To dissolve the at least one polyester, the at least one alkyl (meth)acrylate monomer is preferably brought to a temperature in the range from 20° C. to 45° C.

The at least one polyester is preferably dissolved in the alkyl (meth)acrylate while stirring.

The at least one alkyl (meth)acrylate monomer and the at least one polyester are present in the first liquid phase in homogeneously dispersed form.

The first liquid phase contains for example in the range from 0.1% to 15% by weight of the at least one polyester, preferably in the range from 0.5% to 5% by weight, more preferably in the range from 2.5% to 3.5% by weight, based on the total weight of the first liquid phase.

Preference is therefore also given to a process in which the first liquid phase contains in the range from 0.1% to 15% by weight of at least one polyester, based on the total weight of the first liquid phase.

Accordingly, the first liquid phase contains for example in the range from 85% to 99.9% by weight of alkyl (meth)acrylate monomer, preferably in the range from 95% to 99.5% by weight, more preferably in the range from 96.5% to 97 5% by weight, based on the total weight of the first liquid phase.

Preferably, the percentages by weight of the polyester, the alkyl (meth)acrylate monomer, the at least one initiator described further below that is optionally provided in the first liquid phase, and of the further comonomer, in the first liquid phase add up to 100% by weight.

It is preferable that the first liquid phase does not contain a further solvent aside from the alkyl (meth)acrylate monomer.

Preferably, the first liquid phase consists of the alkyl (meth)acrylate monomer, the polyester, and the initiator and the further comonomer, if used.

The percentages by weight of the polyester, the alkyl (meth)acrylate monomer, and the initiator and of the further comonomer, if used, refer to the percentages by weight before the polyester, the alkyl (meth)acrylate monomer, the initiator, and the further comonomer have reacted with one another.

In the context of the present invention, “alkyl (meth)acrylate monomers” are understood as meaning both alkyl methacrylate monomers and alkyl acrylate monomers. Preference is given to C₁-C₁₂-alkyl (meth)acrylate monomers. “C₁-C₁₂-alkyl (meth)acrylate monomers” are understood as meaning alkyl esters of (meth)acrylic acid having 1 to 12 carbon atoms in the alkyl radical. The alkyl radical may be linear, cyclic and/or branched. In addition, it may also include aromatic radicals.

The term “(meth)acrylic acid” in the context of the present invention encompasses both acrylic acid and methacrylic acid.

For example, alkyl (meth)acrylate monomers of the invention are selected from the group consisting of methyl (meth)acrylate, ethyl (meth)acrylate, propyl (meth)acrylate, n-butyl (meth)acrylate, isobutyl (meth)acrylate, 2-ethylhexyl (meth)acrylate, isopentyl (meth)acrylate, stearyl (meth)acrylate, benzyl (meth)acrylate or lauryl (meth)acrylate.

Preferred alkyl (meth)acrylate monomers are methyl methacrylate, ethyl methacrylate, propyl methacrylate, n-butyl methacrylate, isobutyl methacrylate, methyl acrylate, n-butyl acrylate, isopentyl methacrylate, and mixtures thereof.

Preference is therefore also given in accordance with the invention to a process in which the at least one alkyl (meth)acrylate monomer is also selected from the group consisting of methyl methacrylate, ethyl methacrylate, propyl methacrylate, n-butyl methacrylate, isobutyl methacrylate, isopentyl methacrylate, methyl acrylate, n-butyl acrylate, and mixtures thereof.

The at least one polyester is produced by polycondensation of polycarboxylic acids with polyols. Those skilled in the art will be aware that derivatives of polycarboxylic acids, for example their low alkyl esters and/or their anhydrides, can also be used in the polycondensation.

“Polycarboxylic acids” in the context of the present invention are understood as meaning compounds containing at least two carboxyl groups. The polycarboxylic acids employed in the polycondensation preferably contain just two carboxyl groups. The polycarboxylic acids are in that case referred to also as dicarboxylic acids.

Suitable polycarboxylic acids are those known to those skilled in the art, for example aliphatic polycarboxylic acids, cycloaliphatic polycarboxylic acids and/or aromatic polycarboxylic acids.

Suitable polycarboxylic acids are for example selected from the group consisting of succinic acid, glutaric acid, adipic acid, azelaic acid, sebacic acid, dodecanedioic acid, tetradecanedioic acid, octadecanedioic acid, cyclohexanedicarboxylic acid and isomers thereof, benzenedicarboxylic acid and isomers thereof, and trimellitic acid.

The at least one polyester includes in the range from 0.1 to 10 mol %, preferably in the range from 0.2 to 5 mol %, and more preferably in the range from 0.5 to 1.5 mol %, of polycarboxylic acid units having C—C double bond, based on the total amount of polycarboxylic acid units.

The polyester is therefore usually produced using a mixture of the polycarboxylic acids mentioned above and an unsaturated polycarboxylic acid. An unsaturated polycarboxylic acid is understood as meaning a polycarboxylic acid containing at least one C—C double bond. The C—C double bond may be located for example in the backbone of the polycarboxylic acid. Examples of such polycarboxylic acids are fumaric acid, maleic acid, and mesaconic acid.

In addition, the C—C double bond may be located as a side group in the polycarboxylic acid. An example of such a polycarboxylic acid is itaconic acid.

In the context of the present invention, a C—C double bond that is located as a side group in the polycarboxylic acid and includes a H₂C═C unit is also referred to as a vinyl group. The C—C double bond is preferably a vinyl group.

Preference is therefore also given in accordance with the invention to a process in which the C—C double bond present in the at least one polyester is a vinyl group.

It is in addition preferable in accordance with the invention that the vinyl group is present in an itaconic acid unit. It is therefore preferable that the polycarboxylic acid units having C—C double bond are itaconic acid units.

It is thus preferable in accordance with the invention that the at least one polyester is produced/obtainable by a polycondensation of polycarboxylic acids and polyols employing in the range from 0.1 to 10 mol %, preferably in the range from 0.2 to 5 mol %, and more preferably in the range from 0.5 to 1.5 mol %, of itaconic acid, based on the total amount of polycarboxylic acids.

Polyols in the context of the present invention are understood as meaning compounds containing at least two hydroxyl groups. The polyols employed in the polycondensation preferably contain just two hydroxyl groups. The polyols are in that case referred to also as diols.

Suitable polyols are those known to those skilled in the art, for example aliphatic polyols, aromatic polyols and/or ether diols. Aliphatic polyols are preferred.

Suitable polyols are for example selected from the group consisting of ethylene glycol, propane-1,2-diol, propane-1,3-diol, butane-1,4-diol, pentane-1,5-diol, hexane-1,6-diol, nonane-1,9-diol, dodecane-1, 12-diol, neopentyl glycol, butylethylpropane-1,3-diol, methylpropane-1,3-diol, methylpentanediol, cyclohexanedimethanol, trimethylolpropane, pentaerythritol, hydroquinone, bisphenol A, bisphenol F, dihydroxynaphthalene, ether diols of the abovementioned, and mixtures thereof.

Processes for the production of polyesters are known per se. For example, they can be obtained by polycondensation of polyols with polycarboxylic acids or the esters, anhydrides and/or acid chlorides thereof in an inert gas atmosphere at temperatures from 100° C. to 260° C., preferably from 130° C. to 240° C., in the melt or in an azeotropic operating mode, as described for example in Methoden der organischen Chemie [Methods of organic chemistry] (Houben-Weyl), vol. 14/2, 1-5, 21-23, 40-22, Georg Thieme Verlag, Stuttgart, 1963, in C. R. Martens, Alkyl Resins, 51-59, Reinhold Plastics Appl., Series, Reinhold Publishing Comp., New York, 1961 or in DE 27 35 497.

According to the invention, the at least one polyester includes polycarboxylic acid units and polyol units.

In the context of the present invention, polycarboxylic acid units are understood as meaning units in the polyester that are derived from the polycarboxylic acid. In the context of the present invention, polyol units are understood as meaning units in the polyester that are derived from the polyol Condensation of the polyol with the polycarboxylic acid results in the formation of polyester blocks. The block therein that is derived from the polycarboxylic acid is referred to in the context of the present invention as a polycarboxylic acid unit. The block therein that is derived from the polyol is referred to in the context of the present invention as a polyol unit.

The polycarboxylic acid units are preferably dicarboxylic acid units formed by condensation of a dicarboxylic acid with a polyol. The polyol units are preferably diol units formed by condensation of a diol with the polycarboxylic acid. Particularly preferably, the polycarboxylic acid units are dicarboxylic acid units and the polyol units are diol units. They are formed by condensation of a dicarboxylic acid with a diol.

For example, the at least one polyester has an OH value (hydroxyl value) in the range from 5 mg (KOH)/g to 150 mg (KOH)/g, preferably in the range from 10 mg (KOH)/g to 50 mg (KOH)/g.

The at least one polyester has for example an acid value of less than 10 mg (KOH)/g, preferably of less than 5 mg (KOH)/g, and more preferably of less than 2 mg (KOH)/g.

The at least one polyester has for example a number-average molecular weight (Mn) in the range from 700 to 25 000 g/mol, preferably in the range from 2000 to 12 000 g/mol, determined by GPC or HPLC, in each case with PMMA as standard.

In addition, at least one initiator may be provided in the first liquid phase. If the at least one initiator is provided in the first liquid phase in step a), then it is preferable that no initiator is provided in the second liquid phase in step b) described further below.

In the context of the present invention, “provided either in the first liquid phase in step a) or in the second liquid phase in step b)” thus means that it is preferable that the at least one initiator is provided either only in the first liquid phase in step a), but not in the second liquid phase in step b), or that the at least one initiator is provided only in the second liquid phase in step b), but not in the first liquid phase in step a).

It is self-evident that, although the at least one initiator is provided preferably only in the first liquid phase or only in the second liquid phase, the at least one initiator is able to diffuse from the first liquid phase to the second liquid phase, or vice versa, in the course of the process of the invention, particularly during at least one of steps c) and d).

If the at least one initiator is provided in the first liquid phase in step a), it is usually likewise dissolved in the at least one alkyl (meth)acrylate monomer and is thus present in the form of an initiator dissolved in the at least one alkyl (meth)acrylate monomer.

For example, in the range from 0.1% to 20% by weight, preferably 0.5% to 5% by weight, of the at least one initiator is provided in the first liquid phase in step a), based on the total weight of the first liquid phase.

The at least one initiator is preferably provided in the second liquid phase in step b). It is accordingly preferable that the first liquid phase be provided without an initiator.

In an alternative preferred embodiment, the at least one initiator is provided in the first liquid phase in step a). It is in that case preferable that the second liquid phase be provided without an initiator.

Suitable initiators are all compounds known to those skilled in the art that are capable of initiating a free-radical polymerization. For example, the at least one initiator is selected from the group consisting of peroxides, azo compounds, persulfates, and mixtures thereof. The initiator is preferably selected from the group consisting of peroxides, azo compounds, and mixtures thereof.

Preference is therefore also given to a process in which the at least one initiator is selected from the group consisting of peroxides, azo compounds, and mixtures thereof.

Suitable peroxides are for example selected from the group consisting of hydrogen peroxide, dibenzoyl peroxide, dicyclohexyl peroxodicarbonate, dilauryl peroxide, methyl ethyl ketone peroxide, acetylacetone peroxide, di-tert-butyl peroxide, tert-butyl hydroperoxide, cumene hydroperoxide, tert-butyl peroctanoate, tert-butyl per-2-ethylhexanoate, tert-butyl perneodecanoate, tert-amyl perpivalate, tert-butyl perpivalate, tert-butyl perbenzoate, di (tert-amyl) peroxide (DTAP), tert-butylperoxy 2-ethylhexyl carbonate (TBPEHC), tert-butyl per-2-ethylhexanoate, dicumyl peroxide, diisopropyl peroxydicarbonate and bis (4-t-butylcyclohexyl) peroxydicarbonate.

Suitable azo compounds are for example selected from the group consisting of 2,2-azobisiso-2,4-dimethylvaleronitrile, 2,2-azobisisobutyronitrile, 2,2′-azobis (2-amidinopropane) dihydrochloride, 2-(carbamoylazo) isobutyronitrile, and 4,4′-azobis (cyanovaleric acid).

Suitable persulfates are for example selected from the group consisting of lithium peroxodisulfate, sodium peroxodisulfate, potassium peroxodisulfate, and ammonium peroxodisulfate.

In addition, the first liquid phase may additionally contain a further comonomer. A “further comonomer” in the context of the present invention is understood as meaning a monomer that is copolymerizable with the at least one alkyl (meth)acrylate monomer. It is self-evident that the further comonomer is different from at least one alkyl (meth)acrylate monomer. “A further comonomer” in the context of the present invention means either just one further comonomer or a mixture of two or more comonomers.

Such further comonomers are known per se to those skilled in the art, examples being (meth)acrylic acid, hydroxyethyl methacrylate and/or hydroxypropyl methacrylate.

For example, the first liquid phase contains in the range from 0% to 20% by weight, preferably in the range from 0% to 10% by weight, of the further comonomer, based on the total weight of the first liquid phase.

In one embodiment of the invention, the first liquid phase does not contain a further comonomer. The first liquid phase particularly preferably does not contain styrene

In step b), a second liquid phase comprising water and at least one suspension aid dispersed therein is provided.

For example, the second liquid phase can be provided by dispersing the suspension aid in water while stirring.

The second liquid phase in step b) can be provided at any temperature and is preferably provided at a temperature in the range from 25° C. to 80° C., preferably in the range from 37° C. to 65° C.

In the second liquid phase, water usually forms the continuous phase; the suspension aid forms the disperse phase. The second liquid phase is usually present in the form of a suspension. The suspension aid is present as solid particles in water.

Suitable suspension aids are all suspension aids known to those skilled in the art, for example polyacrylic acids, salts of polyacrylic acids and/or Pickering systems. Examples of suitable Pickering systems are colloidal silicon dioxide and/or aluminum hydroxide. An aluminum hydroxide Pickering system is preferably produced from aluminum sulfate and sodium carbonate (soda).

The suspension aid is preferably selected from the group consisting of polyacrylic acids, salts of polyacrylic acids, and aluminum hydroxide Pickering systems.

Preference is therefore given to a process in which the at least one suspension aid present in the second liquid phase is selected from the group consisting of polyacrylic acids, salts of polyacrylic acids, and aluminum hydroxide Pickering systems.

For example, the second liquid phase contains in the range from 0.01% to 10% by weight, preferably in the range from 0.02% to 5% by weight, of the suspension aid, based on the total weight of the second liquid phase.

Accordingly, the second liquid phase contains for example in the range from 90% to 99.99% by weight, preferably in the range from 95% to 99.98% by weight, of water, based on the total weight of the second liquid phase.

The at least one initiator can be provided in the second liquid phase in step b). If the initiator is provided in the second liquid phase in step b), it is subject to the same embodiments and preferences as those above for the initiator provided in the first liquid phase in step a).

For example, in the range from 0.1% to 20% by weight, preferably in the range from 0.2% to 10% by weight, of initiator, based on the total weight of the second liquid phase, is provided in the second liquid phase in step b).

In step c), the first liquid phase is dispersed in the second liquid phase, wherein droplets of the first liquid phase form in the second liquid phase.

The first liquid phase is usually essentially insoluble in the second liquid phase.

The dispersing in step c) is usually effected by stirring. Droplets of the first liquid phase form in the second liquid phase. The droplets contain the alkyl (meth)acrylate monomer and the polyester dissolved therein and also the further comonomer, if used. The droplets also contain the at least one initiator, either through the initiator having been provided in the first liquid phase or through the initiator diffusing from the second liquid phase into the first liquid phase.

The suspension aid present in the second liquid phase usually surrounds the droplets of the first liquid phase, forming a boundary layer between the first liquid phase and the second liquid phase. The suspension aid thereby stabilizes the droplets of the first liquid phase in the second liquid phase.

The first liquid phase and the second liquid phase usually form an emulsion. The first liquid phase forms the disperse phase therein, while the second liquid phase forms the continuous phase.

The droplets of the first liquid phase in the second liquid phase obtained in step c) have for example a median diameter d₅₀ according to the Coulter method in the range from 0.01 mm to 5 mm, preferably in the range from 0.05 mm to 0.40 mm.

Preference is therefore also given to a process in which the droplets of the first liquid phase obtained in step c) have a median diameter d₅₀ according to the Coulter method in the range from 0.01 mm to 5 mm.

The weight ratio of the first liquid phase to the second liquid phase in step c) is for example in the range from 1:2 to 2:1, preferably about 1:1.

Preference is therefore also given to a process in which the weight ratio of the first liquid phase to the second liquid phase during dispersion in step c) is in the range from 1:2 to 2:1.

The dispersing in step c) usually takes place at a temperature below the temperature at which the alkyl (meth)acrylate monomer and/or polyester present in the first liquid phase polymerize. For example, the dispersing in step c) takes place at a temperature in the range from 20° C. to <50° C., preferably in the range from 35° C. to 45° C.

In step d), the alkyl (meth)acrylate monomer and the polyester present in the first liquid phase, and the further comonomer, if used, are polymerized to obtain the polymer mixture comprising the alkyl (meth)acrylate-polyester copolymer.

The polymerization is usually carried out while stirring.

The polymerization in step d) is usually initiated by the initiator. For example, the initiator forms free radicals by photoactivation and/or by activation at elevated temperatures, for example in the range from 50° C. to 100° C., preferably in the range from 65° C. to 85° C. These free radicals initiate free radical formation at the C—C double bonds of the alkyl (meth)acrylate monomer and/or at the C—C double bond of the polyester. These reactions are known per se.

The polymerization in step d) is carried out for example at a temperature in the range from 50° C. to 100° C., preferably in the range from 65° C. to 85° C.

Preference is therefore also given to a process in which the polymerization in step d) takes place at a temperature in the range from 50° C. to 100° C.

The polymer mixture is usually obtained in step d) in the form of a solid dispersed in the second liquid phase. The polymer mixture obtained in step d) is usually essentially insoluble in the second liquid phase.

The second liquid phase in that case forms a suspension together with the polymer mixture. The second liquid phase forms the continuous phase, while the polymer mixture forms the disperse phase.

In step d), the polymer mixture comprising the alkyl (meth)acrylate-polyester copolymer is obtained.

In the polymerization in step d), the at least one alkyl (meth)acrylate monomer polymerizes with the polyester. In this reaction, the alkyl (meth)acrylate-polyester copolymer is usually formed. In the polymerization, free radicals are formed by the initiator at the C—C double bond of the polycarboxylic acid units of the polyester and/or at the C—C double bond of the alkyl (meth)acrylate monomers. These can react with each other and/or initiate the formation of further free radicals, as a result of which polymerization occurs. This reaction is known per se to those skilled in the art.

This can result for example in the formation of a graft copolymer that contains the alkyl (meth)acrylate monomer or polymers thereof optionally grafted with the further comonomer onto the polyester or copolymers thereof. Polyester main chains and polyalkyl (meth)acrylate side chains are then formed. In the context of the present invention, the term “alkyl (meth)acrylate-polyester copolymer” thus also encompasses such graft copolymers.

Alternatively or in addition, it is possible that block copolymers are formed that contain a block composed of alkyl (meth)acrylate polymers, optionally with further comonomers, and a block composed of the polyester or copolymers thereof. In the context of the present invention, the term “alkyl (meth)acrylate-polyester copolymer” also encompasses such block copolymers.

The polymer mixture contains for example in the range from 5% to 95% by weight, preferably in the range from 10% to 50% by weight, and more preferably in the range from 20% to 30% by weight, of the alkyl (meth)acrylate-polyester copolymer, based on the total weight of the polymer mixture.

In the polymerization in step d), the polyester also usually polymerizes with itself to obtain at least one copolyester Likewise, the at least one alkyl (meth)acrylate monomer can polymerize with itself and with the further comonomer, if used, to obtain at least one alkyl (meth)acrylate polymer

Therefore, in addition to the alkyl (meth)acrylate-polyester copolymer the polymer mixture obtained in step d) usually also contains further polymers, in particular it usually also contains at least one copolyester and/or at least one alkyl (meth)acrylate polymer.

In addition, it is possible that some of the polyester and/or some of the alkyl (meth)acrylate monomers do not react and are present in the polymer mixture.

Alkyl (meth)acrylate monomers and further comonomers, if used, can usually be largely removed from the polymer mixture by drying.

Preference is therefore also given to a process in which the polymer mixture additionally contains the at least one polyester, at least one copolyester and/or at least one alkyl (meth)acrylate polymer. Preferably, it additionally contains at least one polyester, at least one copolyester, and at least one alkyl (meth)acrylate polymer.

The total amount of polyester and copolyester in the polymer mixture is for example in the range from 0.01% to 15% by weight, preferably in the range from 0.01% to 5% by weight, and more preferably in the range from 0.01% to 2% by weight, in each case based on the total weight of the polymer mixture.

The polymer mixture contains for example in the range from 5% to 95% by weight, preferably in the range from 50% to 90% by weight, and more preferably in the range from 70% to 80% by weight, of at least one alkyl (meth)acrylate polymer, in each case based on the total weight of the polymer mixture.

Following step d), the polymer mixture is usually separated from the second liquid phase. The separation may be carried out by any method known to those skilled in the art, for example by filtration and subsequent drying. In this case, the filtration can be carried out using continuously operated decanters and centrifuges and the drying by continuously-operated fluid-bed/fluidized-bed dryers.

Preference is therefore also given to a process in which the polymer mixture obtained in step d) is dried following step d).

After drying, the polymer mixture obtained is usually essentially free of water. For example, the polymer mixture contains at most 5% by weight, preferably at most 1% by weight, of water, based on the total weight of the polymer mixture

The polymer mixture is usually obtained in step d) in the form of polymer beads. These preferably have a median diameter d₅₀, determined by the Coulter method, in the range from 0.01 to 0.6 mm.

The polymer mixture has for example a glass transition temperature Tg in the range from 50° C. to 70° C., determined by differential scanning calorimetry (DSC) according to DIN EN ISO 11357-4.

It is preferable in accordance with the invention that the process of the invention takes place in the absence of styrene. In particular, it is preferable that styrene is not used in any of steps a) to d).

Steps a) to d) of the process of the invention may be carried out in the order stated. In addition, a different order is also possible. Steps may also be carried out concomitantly. For example, the order of steps a) and b) may be reversed and/or steps a) and b) may be performed concomitantly. In addition, additional steps may be carried out.

The present invention also provides a polymer mixture obtainable by the process of the invention.

The polymer mixture is subject to the above-described observations and preferences.

The polymer mixture of the invention is particularly suitable as a binder in printing inks In addition, the polymer mixture of the invention is suitable as a heat-seal lacquer. In general, the polymer mixture of the invention can be used as a compatibilizer in all applications in which poly(meth)acrylate-polyester mixtures are to be dissolved in a solvent.

The present invention therefore also provides for the use of the polymer mixture of the invention as a binder in printing inks.

The invention is elucidated in detail hereinbelow with reference to examples, without the invention being limited thereto.

### EXAMPLES

### Production of a Polymer Mixture by Suspension Polymerization

The suspension polymerization was carried out under a nitrogen atmosphere in a 5 l (5-liter) jacketed HWS glass reactor equipped with a reflux condenser. The reactor was equipped with an InterMIG stirrer having 4 impellers (impeller width: 115 mm or 95 mm, distance between impellers: 110 mm, stirrer speed 300 rpm). The reactor also contained four baffles.

The polymerization was then carried out according to the following steps a) to e).

### A) Providing A First Liquid Phase

The first liquid phase was provided with the components specified in Table 1 and homogenized for three to five minutes with stirring.

### B) Providing a Second Liquid Phase

The second liquid phase was provided with the components specified in Table 1, without the initiator, and homogenized for three to five minutes with stirring.

The initiator was weighed out separately and transferred to the reactor. The second liquid phase was then added and the mixture heated to the specified jacket temperature. The second liquid phase was degassed at 400 mbar for 10 min.

### c) Dispersing the First Liquid Phase in the Second Liquid Phase

At a temperature of about 40° C., the second liquid phase was introduced into the reactor with the first liquid phase, with stirring, at approx. 800 mbar over a period of 20 minutes.

### d) Degassing and Heating

The dispersion obtained was degassed at approx. 400 mbar for 20 min and heated to polymerization temperature.

### d) Polymerizing

The components present in the first liquid phase were polymerized at the temperature specified in Table 1. The end of the polymerization can be seen from the marked rise in heat dissipation (Tmax). A conversion of >90% was achieved. The polymerization time is the time from reaching the polymerization temperature until the maximum temperature is reached.

The mixture was then heated further in accordance with the time and temperature values given in Table 1. After the further heating phase, the mixture is cooled.

### e) Separating

After the resulting bead suspension had been cooled to an internal temperature of approx. 30° C., the mother liquor was separated from the polymer beads by filtration and then dried. The polymer beads obtained were screened with a screen having a mesh size of 1000 μm.

The process of the invention allows polymer mixtures to be produced by suspension polymerization in high yields. The ratio of the first phase to the second phase of 1:2 or 1:1 is particularly advantageous and allows very good space-time yields to be achieved.

### Evaluation

### 1. Determination of Caking

The caking adhering loosely to the stirrer and baffles was rinsed off with water and the amount (weight) thereof determined.

### 2. Visual Assessment of the Beads

The beads were visually assessed using a microscope.

### 3. Assessment of the Mother Liquor

The pH of the mother liquor obtained in the filtration was determined with a pH meter.

### 4. Analysis

The following analytical tests were carried out:
a) Particle size distribution measured by the Coulter method.
b) Residual content of monomer (comparative HPLC)
c) Residual content of chain-transfer agent (comparative HPLC)
d) Residual content of initiator (comparative HPLC)
e) Viscosity number, VN (reduced viscosity) measured with a type 0c Ubbelohde capillary viscometer in accordance with ISO/DIN 3105. DIN 51562, 4-legs
f) Number-average molecular weight, Mw, GPC against PMMA as standard

The results of the evaluations are shown in Table 1.

TABLE 1

| Description | Component | Example 1 | Example 2 |
|---|---|---|---|
| Ratio of first liquid phase to second | Monomer-water ratio | 1:2 | 1:1 |
| liquid phase | | | |
| First liquid phase | | | |
| Total amount of alkyl | Total amount of monomer | 1600 | 2400 |
| (meth)acrylate monomer and | | | |
| polyester [g] | | | |
| Alkyl (meth)acrylate monomer | MMA | 59.0 | 59.0 |
| [% of total amount] | | | |
| Alkyl (meth)acrylate monomer | n-BuMA | 38.0 | 38.0 |
| [% of total amount] | | | |
| Polyester [% of total amount] | Polyester | 3 | 3 |
| Molecular weight regulator [% | Ethylhexyl thioglycolate | 1.4 | 1 |
| based on total amount of alkyl | (TGEH) | | |
| (meth)acrylate and polyester] | | | |
| Initiator [% based on total amount | Dilauroyl peroxide (LPO) | 0.5 | 1 |
| of alkyl (meth)acrylate and | | | |
| polyester] | | | |
| Second liquid phase [g] | | 3271 | 2401 |
| Water [g] | Water | 3162 | 2340 |
| Suspension aid [g] | Polyacrylic acid 13% in | 99.11 | 60.52 |
| | water | | |
| Additive [g] | Potassium hydrogen | 0.63 | 0.47 |
| | sulfate | | |
| Additive [g] | Mowiol | 10 | 15 |
| pH | | 2.85 | 2.92 |
| Degassing after monodosing | | 20/370 | 20/350 |
| time, in minutes/mbar | | | |
| Metering time of first liquid phase | | 25 | 22 |
| [min] | | | |
| Temperature during addition of first | | 37-40 | 37-40 |
| liquid phase [° C.] | | | |
| Polymerization temperature [° C.] | | 76 | 76 |
| Heat-up time to polymerization | | 40 | 35 |
| temperature [min] | | | |
| Time to maximum temperature [min] | | 102 | 105 |
| Further heating temperature [° C.] | | 87 | 87 |
| Further heating time [min] | | 60 | 60 |
| Tmax in reactor [° C.] | | 76.2 | 77.6 |
| Tmax in jacket [° C.] | | 71.8 | 67.6 |
| Caking of stirrer and baffles [g] | | 25.7 | 24.1 |
| Alkyl (meth)acrylate-polyester | | 1544 | 2370 |
| copolymer [g] | | | |
| Coarse material removed by | | 11.8 | 6.8 |
| screening [g] | | | |
| Residual content of monomers | | 0.15/0.05 | 0.11/0.04 |
| MMA/n-BuMA [%] | | | |
| Residual content of initiator [ppm] | | 100 | 110 |
| d50′ by Coulter method [μm] | | 250 | 230 |
| pH of mother liquor | | 3.1 | 3.2 |
| Viscosity number [ml/g] | | 16 | 22 |
| SEC (Mw/D) [g/mol] | | 26450/4.03 | 36600/2.30 |
| Degree of grafting (grafted/ungrafted) | | 27/73 | 29/70 |
| [%] | | | |

The polymer beads obtained in examples 1 and 2 and the polymer according to comparative example 3 (Degalan® 1040 L (from Röhm GmbH; copolymer of polyester and (meth)acrylate 50% in n-propyl acetate)) were subjected to various tests. The following steps were carried out:
1 The polymer beads obtained in examples 1 and 2 or Degalan 1040 L were diluted with ethyl acetate to a solids content of 30% by weight. The solution obtained was visually assessed.
2. Formulation of CAP lacquer: 14% by weight of cellulose acetate propionate (CAP 504.02, from Eastman) was mixed with 28% by weight of ethyl acetate and 53% by weight of ethanol and dissolved on a roller bench. 52% by weight of this solution was dispersed with 4% by weight of di (phenoxyethyl) formal (Desavin, Covestro), 15.5% by weight of ethanol, 8.5% by weight of ethyl acetate, and 20% by weight of Monolite Blue 515303 (Heubach/Heucotech, Ltd.).
3. 5 g of polymer beads or Degalan 1040 L was mixed with 15 g of the CAP lacquer produced in 2.
4. The viscosity of the lacquer obtained in 3 was determined using a RheoStress viscometer (100 s⁻¹, PP35, 100 sec, 23° C.).
5. The CAP solution was applied onto a PET film using a No. 1 spiral squeegee (6 μm wet layer thickness) and dried with a hairdryer.
6. Scapa 1112 adhesive tape was applied over the length of the printing ink and then removed in a jerky manner at an angle of 45°.

TABLE 2

| | | | Comparative |
|---|---|---|---|
| Step | Example 1 | Example 2 | example 3 |
| 1. Visual assessment of solution | turbid, 1/5 | clear, 0/5 | clear, 0/5 |
| 0 to 5, 1-5/5 | | | |
| 0 = clear, 5 = opaque | | | |
| 4. Viscosity [mPa · s] | 65 | 60 | 60 |
| 6. Tape test [detachment in %] | 2 | 1 | 1 |

As can be seen from Table 2, the polymer mixtures produced according to the invention (examples 1 and 2) have properties similar to those of polymer mixtures produced according to known processes (comparative example 3). The slight turbidity in example 1 can be eliminated by simple filtration. The viscosities are as comparable as the adhesion to PET film. Solutions can also be readily produced with the polymer mixtures of the invention.

1. A process for producing a polymer mixture that comprises an alkyl (meth)acrylate-polyester copolymer, the process comprising:
a) providing a first liquid phase comprising at least one alkyl (meth)acrylate monomer and at least one polyester dissolved in the alkyl (meth)acrylate monomer,
b) providing a second liquid phase comprising water and at least one suspension aid dispersed therein,
c) dispersing the first liquid phase in the second liquid phase, wherein droplets of the first liquid phase form in the second liquid phase,
d) polymerizing the at least one alkyl (meth)acrylate monomer present in the first liquid phase and the at least one polyester to obtain the polymer mixture comprising the alkyl (meth)acrylate-polyester copolymer,
wherein the polymerization in d) is initiated by at least one initiator that is provided either in the first liquid phase in a) or in the second liquid phase in b), wherein
the at least one polyester includes polycarboxylic acid units and polyol units, wherein the at least one polyester includes in a range from 0.1 to 10 mol % of polycarboxylic acid units having C—C double bond, based on a total amount of polycarboxylic acid units.

2. The process as claimed in claim 1, wherein the first liquid phase contains in a range from 0.1% to 15% by weight of the at least one polyester, based on a total weight of the first liquid phase.

3. The process as claimed in claim 1, wherein the C—C double bond present in the at least one polyester is a vinyl group.

4. The process as claimed in claim 1, wherein the at least one alkyl (meth)acrylate monomer is also selected from the group consisting of methyl methacrylate, ethyl methacrylate, propyl methacrylate, n-butyl methacrylate, isobutyl methacrylate, isopentyl methacrylate, methyl acrylate, n-butyl acrylate, and mixtures thereof.

5. The process as claimed in claim 1, wherein the at least one initiator is selected from the group consisting of peroxides, azo compounds, and mixtures thereof.

6. The process as claimed in claim 1, wherein the at least one suspension aid present in the second liquid phase is selected from the group consisting of polyacrylic acids, salts of polyacrylic acids, and aluminum hydroxide Pickering systems.

7. The process as claimed in claim 1, wherein a weight ratio of the first liquid phase to the second liquid phase during dispersion in c) is in a range from 1:2 to 2:1.

8. The process as claimed in claim 1, wherein the droplets of the first liquid phase obtained in c) have a diameter in a range from 0.01 mm to 5 mm.

9. The process as claimed in claim 1, wherein polymerization in d) takes place at a temperature in a range from 50° C. to 100° C.

10. The process as claimed in claim 1, wherein the polymer mixture obtained in d) is dried following d).

11. A polymer mixture obtainable by a process as claimed in claim 1.

12. A binder in a printing ink, comprising:
the polymer mixture as claimed in claim 11.
